(19) United States
(12) Patent Application Publication
(10) Pub. No.: US 2023/0323085 A1
(43) Pub. Date: Oct. 12, 2023

(54) HALOGEN FREE FLAME RETARDANT ELASTOMER COMPOSITION, ARTICLES PREPARED FROM THE SAME AND PREPARATION METHODS THEREOF

(71) Applicant: Dow Global Technologies LLC, Midland, MI (US)

(72) Inventors: Tan X. Xin, Shanghai (CN); Qi Yudong, Shanghai (CN); Chen Yong, Shanghai (CN)

(73) Assignee: Dow Global Technologies LLC, Midland, MI (US)

(21) Appl. No.: 18/021,171

(22) PCT Filed: Aug. 13, 2020
(86) PCT No.: PCT/CN2020/108811

§ 371 Date: Feb. 13, 2023

(51) Int. Cl. C08K 5/3492; C08K 3/32

(52) U.S. Cl. CPC C08K 5/34924; C08K 3/32; C08K 2003/323

(57) ABSTRACT

The present disclosure relates to a halogen free flame retardant elastomer composition, a halogen free flame retardant article prepared from the same, and preparation methods thereof.

### FIELD OF THE INVENTION

The present disclosure relates to a halogen free flame retardant elastomer composition, a halogen free flame retardant article prepared from the same, and preparation methods thereof.

### BACKGROUND TECHNOLOGY

Cushion or sealing gaskets are pieces that are placed between two parts to provide damping or create a perfect joint between two surfaces. Elastomers are often used for cushion or sealing gaskets due to their excellent cushion and recovery ability. For cushion or sealing gaskets used in electric vehicle (EV) battery pack, electric appliance, and electronic packaging, flame retardancy is beneficial due to safety concern. The most widely used cushion gasket in EV battery pack is silicone rubber, which has good flame resistance, broad service temperature, and good elasticity. However, flame retardant silicone rubber is usually expensive and has medium mechanical property. Therefore, there is an urgent need for a more cost effective flame retardant cushion gasket with better mechanical properties to replace the incumbent silicone rubber gasket for EV battery pack.

EPDM has been widely used for gasket application due to its excellent elasticity, superior mechanical strength, broad service temperature, excellent water and steam resistance, good chemical resistance, low density and cost-effectiveness. EPDM itself belongs to combustible materials due to its hydrocarbon structure. Flame retardant EPDM technology has been developed and used for decades. However, most of the techniques are based on halogenated flame retardants, which are not environmentally friendly due to their intrinsic toxicity and the potential to release massive amounts of corrosive and toxic gases that may corrode metal components and cause damage to sensitive electronics.

Hydrated metal compounds such as aluminum trihydrate and magnesium hydroxide are commonly used for halogen free flame retardant (HFFR) EPDM solutions. But it usually requires very high flame retardant loading (greater than 50 wt. %) to reach UL94 V-0 flame retardancy. The high loadings of hydrated metal compounds bring limitation of physical properties to this kind of HFFR EPDM compounds. For example, it is very difficult to make soft metal hydroxide based UL94 V-0 rated HFFR EPDM compounds with hardness ranging from 40 to 60 Shore A, which is the typical hardness for EPDM gasket. Besides, the mechanical properties and compression properties will be negatively affected.

Therefore, there is an urgent need for a halogen free flame retardant elastomer composition which can be prepared into an article, such as a cushion gasket, with good flame retardancy, low hardness (40 to 60 Shore A), excellent mechanical strength and compression properties.

### SUMMARY OF THE INVENTION

The present disclosure provides a halogen free flame retardant elastomer composition, an article prepared from the same, and preparation methods thereof. The halogen-free flame retardant articles prepared from the elastomer composition of the present disclosure exhibits both good flame retardancy and low hardness, excellent mechanical properties, and compression properties. The halogen-free flame retardant articles, such as gaskets, are soft (hardness 40-60 Shore A), and could meet UL94 V-0 flame resistance at 1.6 mm thickness, which is very challenging for HFFR EPDM. The tensile strength of these soft articles, such as gaskets, is 5.0-9.0 MPa, which is higher than that of the incumbent silicone gaskets. The density of the halogen-free flame retardant article, such as EPDM gaskets, is lighter than that of incumbent silicone gasket. The compression modulus and compression set resistance are very suitable for cushion and sealing applications.

In a first aspect of the present disclosure, the present disclosure provides a halogen free flame retardant elastomer composition, comprising
A) 100 parts by weight of an ethylene/α-olefin/nonconjugated polyene interpolymer;
B) 0-100 parts by weight of a plasticizer;
C) 0-120 parts by weight of a reinforcing filler;
D) 60-150 parts by weight of a N—P based complex flame retardant;
E) 0-5 parts by weight of a silane coupling agent;
F) 0-5 parts by weight of an antioxidant;
G) 0-8 parts by weight of a processing aid;
H) 2-10 parts by weight of a crosslinking agent;
I) 0-5 parts by weight of a crosslink co-agent.

In a second aspect of the present disclosure, the present disclosure provides a halogen free flame retardant article prepared from a halogen free flame retardant elastomer composition, comprising
A) 100 parts by weight of an ethylene/α-olefin/nonconjugated polyene interpolymer;
B) 0-100 parts by weight of a plasticizer;
C) 0-120 parts by weight of a reinforcing filler;
D) 60-150 parts by weight of a N—P based complex flame retardant;
E) 0-5 parts by weight of a silane coupling agent;
F) 0-5 parts by weight of an antioxidant;
G) 0-8 parts by weight of a processing aid;
H) 2-10 parts by weight of a crosslinking agent;
I) 0-5 parts by weight of a crosslink co-agent.

In a third aspect of the present disclosure, the present disclosure provides a method for preparing the halogen free flame retardant elastomer composition, comprising mixing optional C) a reinforcing filler, D) the N—P based complex flame retardant, and optional B) the plasticizer first, and then adding A) the ethylene/α-olefin/nonconjugated polyene interpolymer and all the remaining components except H) the crosslink agent and optional I) the crosslink co-agent, and finally adding H) the crosslink agent and optional I) the crosslink co-agent.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. Unless indicated otherwise, all the percentages and ratios are calculated based on weight, and all the molecular weights are number average molecular weights.

The term “interpolymer” as used herein, refers to polymers prepared by the polymerization of at least two different types of monomers. The term interpolymer thus includes the term copolymer (employed to refer to polymers prepared from two different types of monomers) and polymers prepared from more than two different types of monomers.

The term “ethylene/α-olefin/nonconjugated polyene interpolymer,” as used herein, refers to a polymer that comprises, in polymerized form, ethylene, an α-olefin, and a nonconjugated polyene. In one embodiment, the “ethylene/α-olefin/nonconjugated polyene interpolymer” comprises a majority weight percent of ethylene (based on the weight of the interpolymer).

The term “ethylene/α-olefin/diene interpolymer,” as used herein, refers to a polymer that comprises, in polymerized form, ethylene, an α-olefin, and a diene. In one embodiment, the “ethylene/α-olefin/diene interpolymer” comprises a majority weight percent of ethylene (based on the weight of the interpolymer).

The terms “comprising”, “including”, “having”, and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The present disclosure provides a halogen free flame retardant elastomer composition, comprising the following components:

A) Ethylene/α-Olefin/Nonconjugated Polyene Interpolymer

The ethylene/α-olefin/nonconjugated polyene interpolymers for the inventive compositions described herein, comprise, in polymerize form, ethylene, an α-olefin, and a nonconjugated polyene. Suitable examples of α-olefins include the C3-C20 α-olefins, further C3-C10 α-olefins, and preferably propylene. Suitable examples of nonconjugated polyenes include the C4-C40 nonconjugated dienes.

The α-olefin may be either an aliphatic or an aromatic compound. The α-olefin is preferably a C3-C20 aliphatic compound, preferably a C3-C16 aliphatic compound, and more preferably a C3-C10 aliphatic compound. Preferred C3-C10 aliphatic α-olefins are selected from the group consisting of propylene, 1-butene, 1-hexene and 1-octene, and more preferably propylene. In a further embodiment, the interpolymer is an ethylene/propylene/diene (EPDM) terpolymer. In a further embodiment, the diene is 5-ethylidene-2-norbornene (ENB).

Illustrative nonconjugated polyenes include straight chain acyclic dienes, such as 1,4-hexadiene and 1,5-heptadiene; branched chain acyclic dienes, such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, 1,9-decadiene, and mixed isomers of dihydromyrcene; single ring alicyclic dienes such as 1,4-cyclohexadiene, 1,5-cyclooctadiene and 1,5-cyclododecadiene; multi-ring alicyclic fused and bridged ring dienes, such as tetrahydroindene, methyl tetrahydroindene; alkenyl, alkylidene, cycloalkenyl and cycloalkylidene norbornenes such as 5-methylene-2-norbornene (MNB), 5-ethylidene-2-norbornene (ENB), 5-vinyl-2-norbornene, 5-propenyl-2-norbornene, 5-isopropylidene-2-norbornene, 5-(4-cyclopentenyl)-2-norbornene, and 5-cyclohexylidene-2-norbornene. The polyene is preferably a nonconjugated diene selected from the group consisting of ENB, dicyclopentadiene, 1,4-hexadiene, 7-methyl-1,6-octadiene, and preferably, ENB, dicyclopentadiene and 1,4-hexadiene, more preferably ENB and dicyclopentadiene, and even more preferably ENB.

In one embodiment, the ethylene/α-olefin/nonconjugated polyene interpolymer comprises a majority amount of polymerized ethylene, based on the weight of the interpolymer. In a further embodiment, the ethylene/α-olefin/nonconjugated polyene interpolymer is an ethylene/α-olefin/diene interpolymer. In a further embodiment, the interpolymer is an EPDM. In a further embodiment, the diene is ENB.

In one embodiment, the ethylene/α-olefin/nonconjugated polyene interpolymer has a molecular weight distribution (Mw/Mn) from 2 to 50, further from 2 to 35, further from 2 to 25. In a further embodiment, the ethylene/α-olefin/nonconjugated polyene interpolymer is an ethylene/α-olefin/diene interpolymer (EAODM). In a further embodiment, the interpolymer is an EPDM. In a further embodiment, the diene is ENB.

In one embodiment, the ethylene/α-olefin/nonconjugated polyene interpolymer has a Mooney viscosity, ML(1+4) at 125° C., greater than, or equal to, 60, further greater than, or equal to, 70, further greater than, or equal to 85, but less than, or e qual to 150, further less than, or equal to 140, further less than, or equal to 130, further less than, or equal to 120. In a further embodiment, the ethylene/α-olefin/nonconjugated polyene interpolymer is an ethylene/α-olefin/diene interpolymer. In a further embodiment, the interpolymer is an EPDM. In a further embodiment, the diene is ENB.

In one embodiment, the ethylene/α-olefin/nonconjugated polyene interpolymer has a Mooney viscosity, ML(1+4) at 125° C., from 60 to 150, or from 60 to 130, or from 65 to 120, or from 70 to 110. In a further embodiment, the ethylene/α-olefin/nonconjugated polyene interpolymer is an ethylene/α-olefin/diene interpolymer. In a further embodiment, the interpolymer is an EPDM. In a further embodiment, the diene is ENB.

Mooney viscosity is that of the neat interpolymer (or calculated viscosity of neat polymer for polymers that contain a filler, such as carbon black, and/or an oil). The neat polymer refers to the polymer without filler and without oil.

An ethylene/alpha-olefin/nonconjugated polyene interpolymer may comprise a combination of two or more embodiments as described herein.

An ethylene/alpha-olefin/diene interpolymer may comprise a combination of two or more embodiments as described herein.

An EPDM terpolymer may comprise a combination of two or more embodiments as described herein.

The EPDM as used in the process according to the present disclosure may for example comprise 40-80 wt % of polymeric units derived from ethylene. Preferably, the EPDM comprises 45-75 wt % of ethylene, more preferably 45-70 wt %.

The EPDM may comprise 20-60 wt % of polymeric units derived from propylene. Preferably, the EPDM comprises 25-55 wt % of polymeric units derived from propylene, more preferably 30-50 wt %.

The EPDM may comprise 0.5-15 wt % of polymeric units derived from a diene monomer. Preferably, the EPDM comprises 1-10 wt % of polymeric units derived from a diene monomer, more preferably 2-8 wt % of polymeric units derived from a diene monomer, still more preferably 4-6 wt % wt %.

The diene monomer may for example be one or more selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), and/or 2,5-norbornadiene. For example, the diene monomer may for example be one selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. For example, the diene monomer may be selected from dicyclopentadiene (DCPD), 5-vinyl-2-norbornene, or 5-ethylidene-2-norbonene (ENB). It is particularly preferred that the diene monomer is 5-ethylidene-2-norbonene (ENB).

The EPDM may for example comprise 0.5-15 wt % of polymeric units derived from one or more selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), and/or 2,5-norbornadiene. The EPDM may for example comprise 0.5-15 wt % of polymeric units derived from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. More preferably, the EPDM comprises 0.5-10 wt %, even more preferably 2-8 wt %, even more preferably 4-6 wt % of polymeric units derived from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. Even more preferably, the EPDM comprises 0.5-15 wt % of polymeric units derived from DCPD, ENB or VNB, even more preferably 2-8 wt %, or 4-6 wt %. In a particular embodiment, the EPDM comprises 0.5-15 wt % of polymeric units derived from ENB, more preferably 2-8 wt %, or 4-6 wt %.

In a particular embodiment, the EPDM comprises 0.5-15 w t %, preferably 2-8 wt %, more preferably 4-6 wt %, of polymeric units derived from a diene monomer, wherein the diene monomer is selected from 1,4-hexadiene, 1,6-octadiene, 5-methyl-1,4-hexadiene, 3,7-dimethyl-1,6-octadiene, dicyclopentadiene (DCPD), 5-vinyl-2-norbornene, 5-ethylidene-2-norbonene (ENB), or 2,5-norbornadiene. More preferably, the EPDM comprises 0.5-15 wt %, preferably 2-8 wt %, more preferably 4-6 wt %, of polymeric units derived from a diene monomer, wherein the diene monomer is selected from dicyclopentadiene (DCPD), 5-vinyl-2-norbornene (VNB), or 5-ethylidene-2-norbonene (ENB). Even more preferably, the EPDM comprises 0.5-15 wt %, preferably 2-8 wt %, more preferably 4-6 wt %, of polymeric units derived from a diene monomer, wherein the diene monomer is 5-ethylidene-2-norbonene (ENB).

In a further particular embodiment, the EPDM comprises:

40.0-80.0 wt % of polymeric units derived from ethylene;

20.0-60.0 wt % of polymeric units derived from propylene; and

0.5-15.0 wt % of polymeric units derived from a diene monomer.

In another particular embodiment, the EPDM comprises:

40.0-80.0 wt % of polymeric units derived from ethylene;

20.0-60.0 wt % of polymeric units derived from propylene; and

0.5-15.0 wt % of polymeric units derived from a diene monomer, wherein the diene monomer is dicyclopentadiene (DCPD), 5-vinyl-2-norbornene (VNB), or 5-ethylidene-2-norbonene (ENB).

It is particularly preferred that the EPDM comprises:

45-75 wt % of polymeric units derived from ethylene;

30-50 wt % of polymeric units derived from propylene; and

2-8 wt % of polymeric units derived from a diene monomer, wherein the diene monomer is 5-ethylidene-2-norbonene (ENB).

Even more particularly is it preferred that the EPDM comprises:

45-70 wt % of polymeric units derived from ethylene;

30-50 wt % of polymeric units derived from propylene; and

4-6 wt % of polymeric units derived from a diene monomer, wherein the diene monomer is 5-ethylidene-2-norbonene (ENB).

B) Plasticizer

The present composition may optionally comprise one or more plasticizers.

The plasticizers include, but are not limited to, petroleum oils, such as aromatic and naphthenic oils; polyalkylbenzene oils; organic acid monoesters, such as alkyl and alkoxyalkyl oleates and stearates; organic acid diesters, such as dialkyl, dialkoxyalkyl, and alkyl aryl phthalates, terephthalates, sebacates, adipates, and glutarates; glycol diesters, such as tri-, tetra-, and polyethylene glycol dialkanoates; paraffinic oils; coumarone-indene resins; pine tars; vegetable oils, such as castor, tall, rapeseed, and soybean oils and esters and epoxidized derivatives thereof; phosphate plasticizer, such as tricresyl phosphate and trioctyl phosphate; and the like.

In an embodiment, the plasticizers include, but are not limited to, paraffinic oil, dioctyl phthalate, dioctyl sebacate, dioctyl adipate, low molecular weight polyisobutylene, naphthenic oil, and dibutyl phthalate.

In one embodiment, the plasticizer is selected from the group consisting of nonaromatic oils, paraffinic oils, naphthenic oils, and combinations thereof. Suitable plasticizers include, but are not limited to, SUNPAR 2280, PARALUX 6001, HYDROBRITE 550, and CALSOL 5550.

The plasticizer is present in an amount from 0 to 100 parts by weight based on 100 parts by weight of ethylene/α-olefin/nonconjugated polyene interpolymer, further from 10 to 98 parts by weight based on 100 parts by weight of ethylene/α-olefin/nonconjugated polyene interpolymer, further from 20 to 95 parts by weight based on 100 parts by weight of ethylene/α-olefin/nonconjugated polyene interpolymer, further from 30 to 95 parts by weight based on 100 parts by weight of ethylene/α-olefin/nonconjugated polyene interpolymer, further from 50 to 90 parts by weight based on 100 parts by weight of ethylene/α-olefin/nonconjugated polyene interpolymer, further from 60 to 90 parts by weight based on 100 parts by weight of ethylene/α-olefin/nonconjugated polyene interpolymer.

C) Reinforcing Filler

The reinforcing filler may be one or more of carbon black, silica, and kaoline. The carbon black may be one or more of N330, N550, N660, N774, N990, and spray carbon black.

The reinforcing filler is present in an amount from 0 to 120 parts by weight based on 100 parts by weight of ethylene/α-olefin/nonconjugated polyene interpolymer, further from 10 to 90 parts by weight based on 100 parts by weight of ethylene/α-olefin/nonconjugated polyene interpolymer, further from 10 to 80 parts by weight based on 100 parts by weight of ethylene/α-olefin/nonconjugated polyene interpolymer, further from 15 to 75 parts by weight based on 100 parts by weight of ethylene/α-olefin/nonconjugated polyene interpolymer.

D) N—P Based Complex Flame Retardant

The N—P based complex flame retardant is a mixture of (1) nitrogen-phosphorous based flame retardants such as melamine cyanurate and ammonium polyphosphate, and (2) flame synergists such as red phosphorous, or a mixture of (1) nitrogen-phosphorous based flame retardants such as melamine cyanurate and ammonium polyphosphate, (2) flame synergists such as red phosphorous, and (3) metal hydroxides such as aluminum hydroxide and magnesium hydroxide. The weight ratio of nitrogen-phosphorous based flame retardants: flame synergists: metal hydroxide is about 20-90: 5-10: 75-0. The flame retardants could be commercially available FR690 or Longsafe 100E.

The N—P based complex flame retardant is present in an amount from 60 to 150 parts by weight based on 100 parts by weight of ethylene/α-olefin/nonconjugated polyene interpolymer, further from 70 to 140 parts by weight based on 100 parts by weight of ethylene/α-olefin/nonconjugated polyene interpolymer, further from 75 to 125 parts by weight based on 100 parts by weight of ethylene/α-olefin/nonconjugated polyene interpolymer, further from 80 to 130 parts by weight based on 100 parts by weight of ethylene/α-olefin/nonconjugated polyene interpolymer.

E) Silane Coupling Agent

The silane coupling agent may be selected from one or more of vinyltriethoxysilane, vinyltrimethoxysilane, vinyltris(β-methoxyethoxy)silane, γ-methacryloxypropyltrimethoxysilane, γ-mercaptopropyltrimethylsilane, γ-mercaptopropyltriethoxysilane, bis(γ-triethoxy silylpropyl)-tetrasulfide, γ-aminopropyltriethoxysilane.

The silane coupling agent is present in an amount from 0 to 5 parts by weight based on 100 parts by weight of ethylene/α-olefin/nonconjugated polyene interpolymer, further from 0.5 to 4.5 parts by weight based on 100 parts by weight of ethylene/α-olefin/nonconjugated polyene interpolymer, further from 1 to 4 parts by weight based on 100 parts by weight of ethylene/α-olefin/nonconjugated polyene interpolymer, further from 1 to 2 parts by weight based on 100 parts by weight of ethylene/α-olefin/nonconjugated polyene interpolymer.

F) Antioxidant

The antioxidant may be selected from one or more of dibutyl nickel dithiocarbamate, 2,2,4-trimethyl-1,2-dihydroquinoline polymer, N-isopropyl-N′-phenyl-p-phenylenediamine, high-temperature reaction products of acetone and diphenylamine, and 2-mercaptobenzimidazole.

The antioxidant is present in an amount from 0 to 5 parts by weight based on 100 parts by weight of ethylene/α-olefin/nonconjugated polyene interpolymer, further from 0.5 to 4.5 parts by weight based on 100 parts by weight of ethylene/α-olefin/nonconjugated polyene interpolymer, further from 1 to 3 parts by weight based on 100 parts by weight of ethylene/α-olefin/nonconjugated polyene interpolymer, further from 1 to 2 parts by weight based on 100 parts by weight of ethylene/α-olefin/nonconjugated polyene interpolymer.

G) Processing Aid

The processing aid may be selected from one or more of polyethylene glycol, polyethylene wax, WB42, WA48, WB212 or a mixture thereof.

The processing aid is present in an amount from 0 to 8 parts by weight based on 100 parts by weight of ethylene/α-olefin/nonconjugated polyene interpolymer, further from 1 to 6 parts by weight based on 100 parts by weight of ethylene/α-olefin/nonconjugated polyene interpolymer, further from 2 to 5 parts by weight based on 100 parts by weight of ethylene/α-olefin/nonconjugated polyene interpolymer, further from 3 to 4.5 parts by weight based on 100 parts by weight of ethylene/α-olefin/nonconjugated polyene interpolymer.

H) Crosslinking Agent

The crosslinking agent may be a peroxide curing agent, sulfur, or a phenolic curing agent.

Suitable peroxides include, but are not limited to, aromatic diacyl peroxides; aliphatic diacyl peroxides; dibasic acid peroxides; ketene peroxides; alkyl peroxyesters; alkyl hydroperoxides (for example, diacetylperoxide; dibenzoylperoxide; bis-2,4-dichlorobenzoyl peroxide; di-tert-butyl peroxide; dicumylperoxide; tert-butyl-perbenzoate; tert-butylcumylperoxide; 2,5-bis (t-butylperoxy)-2,5-dimethylhexane; 2,5-bis (t-butylperoxy)-2,5-dimethyl-3-hexyne; 4,4,4′,4′-tetra-(t-butylperoxy)-2,2-dicyclohexylpropane; 1,4-bis-(t-butylperoxyisopropyl)-benzene; n-butyl-4,4-bis(t-butylperoxy) valerate, 1,1-bis-(t-butylperoxy)-3,3,5-trimethyl-cyclohexane; lauroyl peroxide; succinic acid peroxide; cyclohexanone peroxide; t-butyl peracetate; butyl hydroperoxide; and the like.

The crosslinking agent is present in an amount from 2 to 10 parts by weight based on 100 parts by weight of ethylene/α-olefin/nonconjugated polyene interpolymer, further from 3 to 9 parts by weight based on 100 parts by weight of ethylene/α-olefin/nonconjugated polyene interpolymer, further from 4 to 8 parts by weight based on 100 parts by weight of ethylene/α-olefin/nonconjugated polyene interpolymer, further from 6 to 7.5 parts by weight based on 100 parts by weight of ethylene/α-olefin/nonconjugated polyene interpolymer.

I) Crosslink Co-Agent.

The crosslink co-agent for the peroxide curing agent may be selected from one or more of triallyl cyanurate, trimethylolpropane trimethacrylate, sulfur, ethylene glycol dimethacrylate, N,N′-bisfurfurylacetone, N,N′-m-phenylene bismaleimide, zinc dimethacrylate, triallyl isocyanurate, triallyl trimellitate.

The crosslink co-agent is present in an amount from 0 to 5 parts by weight based on 100 parts by weight of ethylene/α-olefin/nonconjugated polyene interpolymer, further from 0.5 to 4.5 parts by weight based on 100 parts by weight of ethylene/α-olefin/nonconjugated polyene interpolymer, further from 1 to 3 parts by weight based on 100 parts by weight of ethylene/α-olefin/nonconjugated polyene interpolymer, further from 1 to 2 parts by weight based on 100 parts by weight of ethylene/α-olefin/nonconjugated polyene interpolymer.

Other Additives

The present composition may optionally comprise one or more additional additives. Suitable additives include, but are not limited to, fillers, UV stabilizers, colorants or pigments, and combinations thereof.

Fillers include, but are not limited to, silicates of aluminum, magnesium, calcium, sodium, potassium and mixtures thereof; carbonates of calcium, magnesium and mixtures thereof; oxides of silicon, calcium, zinc, iron, titanium, and aluminum; sulfates of calcium, barium, and lead, natural fibers, synthetic fibers, and the like.

The halogen free flame retardant elastomer composition of the present disclosure is free of ethylene-vinyl acetate copolymer (EVA copolymer)

The composition can be prepared by mixing optional C) a reinforcing filler, D) the N—P based complex flame retardant, and optional B) the plasticizer first, and then adding A) the polymer and all the remaining components except H) the crosslink agent and optional I) the crosslink co-agent, and finally adding H) the crosslink agent and optional I) the crosslink co-agent.

The composition of the present disclosure can be molded and cured to afford an article. It can be molded by conventional means in the art, such as compression molding, injection molding, transfer molding and the like. The curing may be conducted at 150-220° C. The article can be used for cushion or sealing gaskets t, preferably used for cushion or sealing gaskets in battery pack, electric appliance and electronic packaging.

The halogen-free flame retardant articles of the present disclosure has a hardness of 40-60 Shore A, and/or meets UL94 V-0 flame resistance at 1.6 mm thickness, and/or has a tensile strength of 5.0-9.0 MPa, and/or a density of 1.10-1.30 g/cc, and/or a compression set resistance of less than 40% after 70 hr @ 150° C., and/or a compressive stress of 0.4-1.6 MPa at a compression strain of 10%, and/or a compressive stress of 1.5-3.0 MPa at a compression strain of 20%, and/or a compressive stress of 2.7-4.0 MPa at a compression strain of 30%.

Preferably, the halogen-free flame retardant articles of the present disclosure has a hardness of 45-60 Shore A, and/or meets UL94 V-0 flame resistance at 1.6 mm thickness, and/or has a tensile strength of 6.0-9.0 MPa, and/or a compression set resistance of less than 37% after 70 hr @ 150° C., and/or a compressive stress of 0.8-1.5 MPa at a compression strain of 10%, and/or a compressive stress of 1.8-3.0 MPa at a compression strain of 20%, and/or a compressive stress of 3.0-4.0 MPa at a compression strain of 30%.

### Examples

Some embodiments of the invention will now be described in the following Examples. However, the scope of the present disclosure is not, of course, limited to the formulations set forth in these examples. Rather, the Examples are merely inventive of the disclosure.

The information of the raw materials used in the examples is listed in the following Table 1:

TABLE 1
Raw materials used in the examples

| Name | Description | Supplier |
|---|---|---|
| XUS51111 (75 phr oil | Neat EPDM Mooney | Dow Chemical |
| extended) | viscosity 130 MU, often | |
| | used in the oil-extended | |
| | form | |
| NORDEL™ 4590 | EPDM, Mooney viscosity | Dow Chemical |
| | 90 MU | |
| NORDEL™ 4571XFM | EPDM, Mooney viscosity | Dow Chemical |
| | 70 MU | |
| NORDEL™ 4570 | EPDM, Mooney viscosity | Dow Chemical |
| | 70 MU | |
| NORDELIM 4520 | EPDM, Mooney viscosity | Dow Chemical |
| | 20 MU | |
| NORDEL™ 4640 | EPDM, Mooney viscosity | Dow Chemical |
| | 40 MU | |
| Sunpar 2280 | Plasticizer | Sunoco |
| CB N550 | Carbon black, reinforcing | Cabot |
| | filler | |
| FR690 | N-P based complex flame | UJIUH |
| | retardant | |
| Talc | Flame retardant | Imerys |
| Al(OH)3 (OL-104LEO) | Flame retardant | Huber |
| ZnO-80 | Activator | Rhein Chemie |
| SG-Si171 | Silane coupling agent | Evonik |
| TMQ | Antioxidant | Westco |
| Structol WB 212 | Processing aid | Rhein Chemie |
| PEG8000 | Processing aid | Sigma-Aldrich |
| Luperox F40 | Crosslink agent | Arkema |
| Luperox 101XL45 | Crosslink agent | Arkema |
| SR350 | Crosslink co-agent | Sartomer |

Sample Preparation

(1) Compound Mixing

A typical “upside-down” mixing procedure was used to mix all compounds as shown in Table 2. The initial mixing temperature was 40° C. Carbon black, the retardant, and the plasticizer were mixed in an internal mixer (IM1.5E Laboratory Mixer made by HF mixing group) slowly at 10 rpm for 120 seconds, after which polymer and all the remaining components except peroxide crosslink agent and crosslink co-agent were added. Mixing was continued for another 5 minutes at 30 rpm, after which the peroxide crosslink agent and the crosslink co-agent were added. The mixture were mixed for another 5 minutes and dumped out at about 100° C. The fill factor was 0.80. Further mixing was completed on a 6″ two-roll mill (SYM-8-18 made by Well Shyang Machinery Co., Ltd), and a 0.2″ thick blanket was sheeted out for rheology and mechanical testing.

(2) Compression Molding and Curing

The blanket obtained above was compression molded and cured on a hot press for t90+5 minutes at 180° C. for tensile test following ASTM D3182-5. Testing specimens were cut from the cured EPDM sheets.

Characterization & Testing

(1) Tensile Test

The tensile properties of the cured sheets were tested per ASTM D1708.

(2) Compression Test

The compression properties of the cured EPDM sheets were obtained following ASTM D575. The specimen size was 50 mm×50 mm×2 mm. The preload force was 50 N, and the compression rate was 2 mm/min.

(3) Compression Set

The compression set was measured at 70 hr @150° C. per ASTM D395 Method B.

(4) UL94 Vertical Burning Test

The flame resistance were tested and rated per UL94 vertical burning standard.

(5) Mooney Viscosity

Mooney viscosity of all EPDMs was measured at 125° C. using an Alpha Technologies Mooney Viscometer following ASTM D1646-19.

The key properties of all inventive examples and comparative examples were compared in Table 2.

A commercially available silicone cushion gasket used in the battery pack is used as the comparative example CE0. Based on the hardness and compressive stress, which are the key parameters of the cushion gasket, IE2 and 1E3 are the most similar materials to the silicone rubber gasket material CE-0. There are several advantages of the inventive examples (IE2) over the silicone rubber gasket. Firstly, the material cost of IE-2 is about 30% cheaper than that of the silicone rubber gasket. Secondly, the density of the IE-2 is 16% lower than of the CE0. Moreover, the tensile strength of IE-2 is 8.6 MPa, about twice that of the silicone rubber gasket. The last but not the least, the compression set of IE-2, which is key indicator of the long term compressive force or sealing force, is 33% lower (better) than that of the silicone rubber gasket.

The hardness of all examples was within 40-60 Shore A, which was the typical hardness of EPDM gaskets. The tensile strengths of IE1-IE6 are very good (6 MPa-9 MPa), which were significantly higher than those of the comparative examples (3 MPa-5 MPa). The compression set of the six inventive examples were all less than 40% after 70 hr @ 150° C. By contrast, the compression set of the comparative examples were higher than 45%. The low compression set indicated excellent sealing ability and compressive stress retention of EPDM materials.

The compressive stress, which indicates sealing force, was also studied. 10%-30% are very common initial compression strain for static seals or cushion gaskets. The compressive stress of all examples was 0.8-41 MPa at compression strain of 10%-30%, which were very suitable for sealing or cushion application. More importantly, IE1-IE6 pass UL94 V-0 flame resistance criteria at the thickness of 1.6 mm without the addition of any halogen ingredients, while CE1-CE2 failed the UL94 vertical burning test.

Compared with CE1-4, IE3 has lighter density, higher mechanical strength, better extensibility, lower (better) compression set, and flame retardancy, which showed the importance of the Mooney viscosity of the EDPM on the properties of the EPDM sheet and the importance of the N—P based complex fire retardant on the properties of the EPDM sheet.

TABLE 2
Compositions of examples

| | | | | | | | CE0 | | | | |
|---|---|---|---|---|---|---|---|---|---|---|---|
| | | | | | | | (vs. | CE1 | CE2 | CE3 | CE4 |
| | | | | | | | IE2&I | (vs. | (vs. | (vs | (vs. |
| Example | IE1 | IE2 | IE3 | IE4 | IE5 | IE6 | E3) | IE3) | IE3) | IE3) | IE3) |
| Feature | XUS5 | XUS5 | NOR | NOR | NOR | NOR | Silicone | Talc | ATH | Low | Medium |
| | 1111-1 | 1111-2 | DEL ™ | DEL ™ | DEL ™ | DEL ™ | Gasket | | | Mooney | Mooney |
| | | | 4590 | 4571-1 | 4570 | 4571-2 | | | | (20) | (40) |
| XUS51111 | 175 | 175 | | | | | | | | | |
| (75 phr oil | | | | | | | | | | | |
| extended) | | | | | | | | | | | |
| NORDEL ™ | | | 100 | | | | | 100 | 100 | | |
| 4590 | | | | | | | | | | | |
| NORDEL ™ | | | | 100 | | 100 | | | | | |
| 4571XFM | | | | | | | | | | | |
| NORDEL ™ | | | | | 100 | | | | | | |
| 4570 | | | | | | | | | | | |
| NORDEL ™ | | | | | | | | | | 100 | |
| 4520 | | | | | | | | | | | |
| NORDEL ™ | | | | | | | | | | | 100 |
| 4640 | | | | | | | | | | | |
| Sunpar 2280 | 15 | 15 | 65 | 65 | 65 | 20 | | 65 | 65 | 65 | 65 |
| CB N550 | 20 | 75 | 60 | 60 | 60 | 25 | | 60 | 60 | 60 | 60 |
| FR690 | 130 | 130 | 110 | 110 | 110 | 80 | | | | 110 | 110 |
| Talc | | | | | | | | 110 | | | |
| Al(OH)3 | | | | | | | | | 110 | | |
| (OL-104LEO) | | | | | | | | | | | |
| ZnO-80 | 3 | 3 | 3 | 3 | 3 | 3 | | 3 | 3 | 3 | 3 |
| SG-Si171 | 2 | 2 | 2 | 2 | 2 | 2 | | 2 | 2 | 2 | 2 |
| TMQ | 1 | 1 | 1 | 1 | 1 | 1 | | 1 | 1 | 1 | 1 |
| WB 212 | 2 | 2 | 2 | 2 | 2 | 2 | | 2 | 2 | 2 | 2 |
| PEG8000 | 2 | 2 | 2 | 2 | 2 | 2 | | 2 | 2 | 2 | 2 |
| Luperox F40 | 3 | 3 | 3 | 3 | 3 | 3 | | 3 | 3 | 3 | 3 |
| Luperox | 4 | 4 | 4 | 4 | 4 | 4 | | 4 | 4 | 4 | 4 |
| 101XL45 | | | | | | | | | | | |
| SR350 | 1.5 | 1.5 | 1.5 | 1.5 | 1.5 | 1.5 | | 1.5 | 1.5 | 1.5 | 1.5 |
| Total | 358.5 | 413.5 | 353.5 | 353.5 | 353.5 | 243.5 | | 353.5 | 353.5 | 353.5 | 353.5 |
| Feature | XUS5 | XUS5 | N459 | N457 | N457 | N457 | Silicone | Talc | ATH | Low | Medium |
| | 1111-1 | 1111-2 | 0 | 1-2 | 0 | 1-2 | Gasket | | | Mooney | Mooney |
| | | | | | | | | | | (20) | (40) |
| Density (g/cc) | 1.14 | 1.19 | 1.21 | 1.22 | 1.23 | 1.2 | 1.42 | 1.29 | 1.26 | 1.23 | 1.23 |
| Hardness | 45 | 59 | 55 | 53 | 56 | 60 | 60 | 50 | 45 | 52 | 54 |
| (Shore A) | | | | | | | | | | | |
| 100% | 0.9 | 2 | 1.5 | 1.3 | 1.4 | 1.59 | 1.8 | 1.1 | 0.7 | 1.1 | 1.3 |
| modulus | | | | | | | | | | | |
| (Mpa) | | | | | | | | | | | |
| TS (Mpa) | 6.3 | 8.6 | 6.5 | 6 | 6.1 | 7.3 | 4.7 | 3.9 | 4.3 | 3.5 | 4.5 |
| EB (%) | 823 | 516 | 619 | 618 | 600 | 525 | 370 | 898 | 883 | 503 | 517 |
| Compression | | | | | | | | | | | |
| set resistance | | | | | | | | | | | |
| 70 h@150° C. | 27.2 | 19.6 | 25 | 28.7 | 35 | 17.8 | — | 59.6 | 57.1 | 62.6 | 49.2 |
| (button) | | | | | | | | | | | |
| 70 h@150° C. | | 36.7 | | | | | 54.6 | | | | |
| (plied disks) | | | | | | | | | | | |
| UL94 vertical | V-0 | V-0 | V-0 | V-0 | V-0 | V-0 | V-0 | NR | NR | V-0 | V-0 |
| burning (1.6 | | | | | | | | | | | |
| mm) | | | | | | | | | | | |
| Compression | | | | | | | | | | | |
| property | | | | | | | | | | | |
| (50 * 50 * 2 mm) | | | | | | | | | | | |
| Compressive | 0.79 ± | 1.22 ± | 1.16 ± | 0.81 ± | 1.19 ± | 1.33 ± | 1.14 ± | 0.70 ± | 0.75 ± | 0.85 ± | 0.97 ± |
| stress @10% | 0.33 | 0.19 | 0.11 | 0.13 | 0.09 | 0.12 | 0.04 | 0.08 | 0.03 | 0.03 | 0.06 |
| strain (Mpa) | | | | | | | | | | | |
| Compressive | 1.93 ± | 2.43 ± | 2.49 ± | 1.83 ± | 2.52 ± | 2.66 ± | 2.58 ± | 1.76 ± | 1.72 ± | 1.76 ± | 2.10 ± |
| stress @20% | 0.37 | 0.29 | 0.13 | 0.26 | 0.10 | 0.25 | 0.06 | 0.11 | 0.05 | 0.15 | 0.05 |
| strain (Mpa) | | | | | | | | | | | |
| Compressive | 3.00 ± | 3.36 ± | 3.67 ± | 2.81 ± | 3.72 ± | 3.68 ± | — | 2.79 ± | 2.60 ± | 2.90 ± | 3.72 ± |
| stress @30% | 0.35 | 0.31 | 0.13 | 0.39 | 0.22 | 0.18 | | 0.16 | 0.09 | 0.07 | 0.19 |
| strain (Mpa) | | | | | | | | | | | |
| Compressive | 7.70 ± | 5.10 ± | 5.43 ± | 7.11 ± | 5.50 ± | 4.75 ± | 5.41 ± | 8.11 ± | 7.51 ± | 7.32 ± | 6.88 ± |
| strain @ 0.5 | 3.10 | 0.74 | 0.73 | 0.98 | 0.45 | 1.20 | 0.22 | 0.69 | 0.23 | 0.46 | 0.30 |
| Mpa (%) | | | | | | | | | | | |

*NR: Not rated, fail to pass UL94 V-0, V-1, V-2 standard.

What is claimed is:

1. A halogen free flame retardant elastomer composition, comprising
A) 100 parts by weight of an ethylene/α-olefin/nonconjugated polyene interpolymer;
B) 0-100 parts by weight of a plasticizer;
C) 0-120 parts by weight of a reinforcing filler;
D) 60-150 parts by weight of a N—P based complex flame retardant;
E) 0-5 parts by weight of a silane coupling agent;
F) 0-5 parts by weight of an antioxidant;
G) 0-8 parts by weight of a processing aid;
H) 2-10 parts by weight of a crosslinking agent;
I) 0-5 parts by weight of a crosslink co-agent.

2. The composition of claim 1, wherein the ethylene/α-olefin/nonconjugated polyene interpolymer is an ethylene/propylene/diene interpolymer (EPDM).

3. The composition of claim 2, wherein the diene monomer is dicyclopentadiene (DCPD), 5-vinyl-2-norbornene (VNB), or 5-ethylidene-2-norbonene (ENB).

4. The composition of claim 1 or 2, wherein the ethylene/α-olefin/nonconjugated polyene interpolymer comprises:
40.0-80.0 wt % of polymeric units derived from ethylene;
20-60 wt % of polymeric units derived from propylene; and
0.5-15.0 wt % of polymeric units derived from a diene monomer, wherein the diene monomer is dicyclopentadiene (DCPD), 5-vinyl-2-norbornene (VNB), or 5-ethylidene-2-norbonene (ENB).

5. The composition of claim 1 or 2, wherein the ethylene/α-olefin/nonconjugated polyene interpolymer comprises:
45-70 wt % of polymeric units derived from ethylene;
30-50 wt % of polymeric units derived from propylene; and
4-6 wt % of polymeric units derived from a diene monomer, wherein the diene monomer is 5-ethylidene-2-norbonene (ENB).

6. The composition of claim 1, wherein the ethylene/α-olefin/nonconjugated polyene interpolymer has a Mooney viscosity, ML(1+4) at 125° C., from 55 to 150.

7. The composition of claim 1, wherein the N—P based complex flame retardant is a mixture of (1) nitrogen-phosphorous based flame retardants and (2) flame synergists, or a mixture of (1) nitrogen-phosphorous based flame retardants, (2) flame synergists and (3) metal hydroxides.

8. The composition of claim 1, wherein the N—P based complex flame retardant is present in an amount from 80 to 130 parts by weight based on 100 parts by weight of ethylene/α-olefin/nonconjugated polyene interpolymer.

9. A halogen free flame retardant article prepared from a halogen free flame retardant elastomer composition of any one of claims 1-8, comprising
A) 100 parts by weight of an ethylene/α-olefin/nonconjugated polyene interpolymer;
B) 0-100 parts by weight of a plasticizer;
C) 0-120 parts by weight of a reinforcing filler;
D) 60-150 parts by weight of a N—P based complex flame retardant;
E) 0-5 parts by weight of a silane coupling agent;
F) 0-5 parts by weight of an antioxidant;
G) 0-8 parts by weight of a processing aid;
H) 2-10 parts by weight of a crosslinking agent;
I) 0-5 parts by weight of a crosslink co-agent.

10. The article of claim 9, wherein the article is used for cushion or sealing gaskets.

11. The article of claim 9, wherein the article is used for cushion or sealing gaskets in battery pack, electric appliance and electronic packaging.

12. The article of claim 9, wherein the article has a hardness of 40-60 Shore A, and/or meets UL94 V-0 flame resistance at 1.6 mm thickness, and/or has a tensile strength of 5.0-9.0 MPa, and/or a density of 1.10-1.30 g/cc, and/or a compression set resistance of less than 40% after 70 hr @ 150° C., and/or a compressive stress of 0.4-1.6 MPa at a compression strain of 10%, and/or a compressive stress of 1.5-3.0 MPa at a compression strain of 20%, and/or a compressive stress of 2.7-4.0 MPa at a compression strain of 30%.

13. A method for preparing the halogen free flame retardant elastomer composition of any one of claims 1-8, comprising mixing optional C) the reinforcing filler, D) the N—P based complex flame retardant, and optional B) the plasticizer first, and then adding A) the ethylene/α-olefin/nonconjugated polyene interpolymer and all the remaining components except H) the crosslink agent and optional I) the crosslink co-agent, and finally adding H) the crosslink agent and optional I) the crosslink co-agent.
